(19) United States
(12) Patent Application Publication
(10) Pub. No.: US 2006/0130241 A1
(43) Pub. Date: Jun. 22, 2006

(54) Method for producing leather

(75) Inventors: Stephan Huffer, Ludwigshafen (DE); Gerhard Wolf, Ketsch (DE); Matthias Kluglein, Ludwigshafen (DE); Matthias Kroner, Eisenberg (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/544,138

(22) PCT Filed: Jan. 29, 2004
(86) PCT No.: PCT/EP04/00777

§ 371 Date: Aug. 2, 2005

(30) Foreign Application Priority Data
Feb. 6, 2003 (DE) 10304959.2

(51) Int. Cl. C14C 1/00

(52) U.S. Cl. 8/94.15

(57) ABSTRACT

In a process for the production of leather, pelts, pickled pelts or semifinished products are treated with at least one polymer which is obtainable by copolymerization of at least one ethylenically unsaturated dicarboxylic anhydride (A), derived from at least one dicarboxylic acid of 4 to 8 carbon atoms, at least one vinylaromatic compound (B) and optionally at least one ethylenically unsaturated monomer (C) which differs from (A) and has a hetero atom, reaction with at least one compound (D) of the formula Ia or Ib 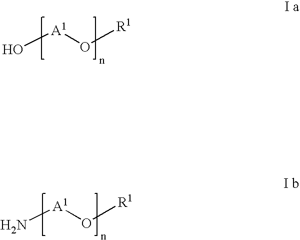 at least 0.55 equivalent, based on (A), of (D) being used, and optionally hydrolysis with water or aqueous alkaline solution, where, in formulae Ia and Ib, the variables are defined as follows:

A¹ are identical or different and are C₂-C₆-alkylene

R¹ is linear or branched C₁-C₂₀-alkyl, and n is an integer from 6 to 200.

The present invention relates to a process for the production of leather, wherein pelts, pickled pelts or semifinished products are treated with at least one polymer which is obtainable by copolymerization of at least one ethylenically unsaturated dicarboxylic anhydride (A), derived from at least one dicarboxylic acid of 4 to 8 carbon atoms, at least one vinylaromatic compound (B) and optionally at least one ethylenically unsaturated monomer (C) differing from (A) and having at least one hetero atom, reaction with at least one compound (D) of the formula Ia or Ib

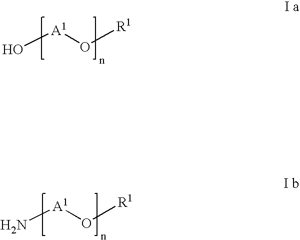

at least 0.55 equivalent, based on (A), of (D) being used,

and optionally hydrolysis with water or aqueous alkaline solution,

in formulae Ia and Ib the variables being defined as follows:

A¹ are identical or different and are C₂-C₆-alkylene

R¹ is linear or branched C₁-C₂₀-alkyl and

n is an integer from 6 to 200.

For the production of leather, polymers can be used in the pretanning, main tanning and retanning. For using polymers in the pretanning, chromium compounds can be completely or at least partly dispensed with in many cases. The choice of the polymer can be influenced by the properties of the leather end product. Regarding the choice of the polymers, various proposals have been made in the literature.

EP-A 0 628 085 describes the use of copolymers of maleic anhydride and optionally a second monomer, for example styrene, isobutene or vinyl acetate, the copolymers being reacted with alkoxylated alcohols before being used for retanning and filling.

EP-A 0 372 746 discloses the use of amphiphilic copolymers of methacrylic acid and, for example, cetyleicosyl methacrylate (process example A) or of acrylic acid with α-hexadecene (process example C) for the aftertreatment of leather. The use of such polymers is limited to the aftertreatment of chrome-tanned leathers (cf. page 8, lines 50-54).

EP-A 0 792 377 discloses a process in which the tanning and optionally also the pretanning is carried out by means of aldehydes or other reactive carbonyl compounds in the presence of polymers, for example maleic anhydride/a-olefin/styrene terpolymers (variant I). The leathers thus produced have good lighffastness and stability to heat yellowing. However, the tensile strength of the leathers thus produced is not yet satisfactory.

For the treatment of, in particular, soft leathers, however, the polymers mentioned in the prior art are still not optimum. For example, the leathers produced by the methods to date can be improved in their body, their grain characteristics and the surface properties. Furthermore, the distribution of the fats used in the retanning in the leather cross section is not yet optimum.

It is an object of the present invention to provide an improved process for the production of leather, which process avoids the abovementioned weaknesses.

We have found that this object is achieved by the process defined at the outset. It starts from at least one of the polymers defined at the outset, which has the following composition. Polymers defined at the outset comprise, as monomers incorporated in the form of polymerized units,

at least one ethylenically unsaturated dicarboxylic anhydride (A), derived from at least one dicarboxylic acid of 4 to 8 carbon atoms, for example maleic anhydride, itaconic anhydride, citraconic anhydride or methylenemalonic anhydride, preferably itaconic anhydride and maleic anhydride, very particularly preferably maleic anhydride;

at least one vinylaromatic compound (B), for example of the formula VIII

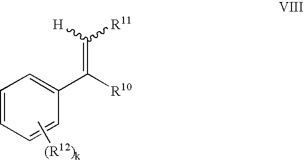

where R¹⁰ and R¹¹, independently of one another, are each hydrogen, methyl or ethyl, preferably hydrogen, R¹² is methyl or ethyl and k is an integer from 0 to 2, preferably 0; and

optionally at least one ethylenically unsaturated monomer (C) which differs from (A) and has at least one hetero atom, and are reacted with at least one compound (D) of the formula Ia or Ib, preferably Ia

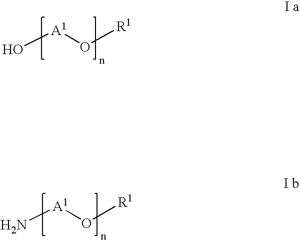

in which the variables are defined as follows:
A¹ are identical or different and are C₂-C₆-alkylene, for example —CH₂—, —CH(CH₃)—, —(CH₂)₂—, —CH₂—CH(CH₃)—, —(CH₂)₃—, —CH₂—CH(C₂H₅)—, —(CH₂)₄—, —(CH₂)₆—, preferably C₂-C₄-alkylene; in particular —(CH₂)₂—, —CH₂—CH(CH₃)— and —CH₂—CH(C₂H₅)—;
R¹ is linear or branched C₁-C₂₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl, n-hexadecyl, n-octadecyl or n-eicosyl; particularly preferably C₁-C₄-alkyl, such as methyl, ethyl, n-propyl, isopropyl, n-butyl, isobutyl, sec-butyl or tert-butyl;
n is an integer from 6 to 200, preferably from 7 to 25.

At least 0.55 equivalent, based on (A), of (D), is used.

In an embodiment of the present invention, up to one equivalent, based on the sum of (A)+(C), of (D) can be used.

In an embodiment of the present invention, up to one equivalent, based on (A), of (D) can be used.

The reaction with (D) is preferably effected after the copolymerization of (A) with (B) and, if required, with (C).

Particular examples of compounds of the formula of Ia are
polyethylene glycols blocked with terminal methyl groups and of the formula HO—(CH₂CH₂O)ₘ—CH₃, where m is from 6 to 200, preferably from 7 to 100, particularly preferably 7-50,
block copolymers of ethylene oxide, propylene oxide and/or butylene oxide, blocked with terminal methyl groups and having a molecular weight M_{w} of from 300 to 5 000 g/mol,
random copolymers of ethylene oxide, propylene oxide and/or butylene oxide, blocked with terminal methyl groups and having a molecular weight M_{w} of from 300 to 5 000 g/mol,
alkoxylated C₂- to C₃₀-alcohols, in particular fatty alcohol alkoxylates, oxo alcohol alkoxylates of Guerbet alcohol alkoxylates, it being possible for the alkoxylation to be carried out with ethylene oxide, propylene oxide and/or butylene oxide. Examples are
C₁₃-C₁₅-oxo alcohol ethoxylates having 6 to 30 ethylene oxide units,
C₁₃-oxo alcohol ethoxylates having 6 to 30 ethylene oxide units,
C₁₂-C₁₄-fatty alcohol alkoxylates having 6 to 30 ethylene oxide units,
C₁₀-oxo alcohol ethoxylates having 6 to 30 ethylene oxide units,
C₁₀-Guerbet alcohol ethoxylates having 6 to 30 ethylene oxide units,
C₉-C₁₁-oxo alcohol alkoxylates having 6-20 ethylene oxide units, 6-20 propylene oxide units and/or at least 6 butylene oxide units;

C₁₃-C₁₅-oxo alcohol alkoxylates having 6-20 ethylene oxide units, 6-20 propylene oxide units and/or at least 6 butylene oxide units;

C₄-C₂₀-alcohol ethoxylates having 6 to 20 ethylene oxide units.

Styrene is preferably used as monomer (B).

The monomer or monomers (C) which can be optionally incorporated as polymerized units in the polymers used in the novel process differ from (A) and have a hetero atom, for example oxygen, nitrogen or sulfur. Examples of preferred monomers (C) having at least one hetero atom are:

C₃-C₈-carboxylic acid derivatives of the formula II 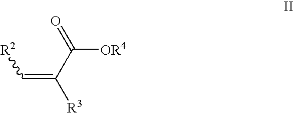
acrylamides of the formula III 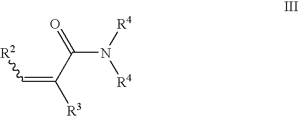
acyclic amides of the formula IVa and cyclic amides of the formula IVb

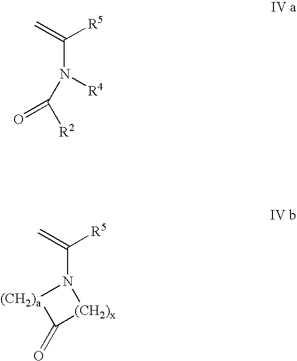

C₁-C₂₀-alkyl vinyl ethers, such as methyl vinyl ether, ethyl vinyl ether, n-propyl vinyl ether, isopropyl vinyl ether, n-butyl vinyl ether, isobutyl vinyl ether, 2-ethylhexyl vinyl ether or n-octadecyl vinyl ether;

N-vinyl derivatives of nitrogen-containing aromatic compounds, preferably N-vinylimidazole, 2-methyl-1-vinylimidazole, N-vinyloxazolidone, N-vinyltriazole, 2-vinylpyridine, 4-vinylpyridine, 4-vinylpyridine N-oxide, N-vinylimidazoline, N-vinyl-2-methylimidazoline,

α,β-unsaturated nitriles, for example acrylonitrile and methacrylonitrile;

alkoxylated unsaturated ethers of the formula V,

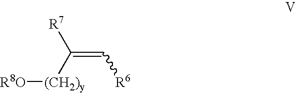

esters and amides of the formula VI,

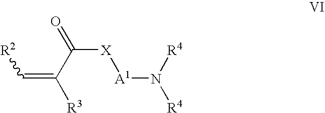

unsaturated esters of the formula VII

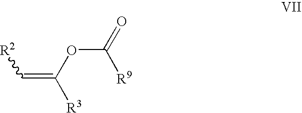

the variables being defined as follows:
R² and R³ are identical or different and are selected from straight-chain and branched C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl; particularly preferably C₁-C₄-alkyl, such as methyl, ethyl, n-propyl, isopropyl, n-butyl, isobutyl, sec-butyl and tert-butyl, in particular hydrogen;
R⁴ are identical or different and are branched or straight-chain C₁-C₂₂-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl, n-eicosyl; particularly preferably C₁-C₄-alkyl, such as methyl, ethyl, n-propyl, isopropyl, n-butyl, isobutyl, sec-butyl and tert-butyl, particularly preferably hydrogen;
R⁵ is hydrogen or methyl,
x is an integer from 2 to 6, preferably from 3 to 5;
y is an integer selected from 0 and 1, preferably 1;
a is an integer from 0 to 6, preferably from 0 to 2;
R⁶ and R⁷ are identical or different and are selected from hydrogen and straight-chain and branched C₁-C₁₀-alkyl, straight-chain and branched C₁-C₁₀-alkyl being as defined above;
X is oxygen or N—R⁴;
R⁸ is [A¹-O]ₙ—R⁴,
R⁹ is selected from straight-chain and branched C₁-C₂₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl, n-tetradecyl, n-hexadecyl, n-octadecyl, n-eicosyl; particularly preferably C₁-C₁₄-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl, n-tetradecyl; in particular hydrogen or methyl.

The other variables are as defined above.

Compounds of the formula III which are selected by way of example are (meth)acrylamides, such as acrylamide, N-methylacrylamide, N,N-dimethylacrylamide, N-ethylacrylamide, N-propylacrylamide, N-tert-butylacrylamide, N-tert-octylacrylamide, N-undecylacrylamide, and the corresponding methacrylamides.

Compounds of the formula IV a which are selected by way of example are N-vinylcarboxamides, such as N-vinylformamide, N-vinyl-N-methylformamide, N-vinylacetamide or N-vinyl-N-methylacetamide; typical compounds of the formula IVb which are selected by way of example are N-vinylpyrrolidone, N-vinyl-4-piperidone and N-vinyl-ε-caprolactam.

Compounds of the formula VI which are selected by way of example are (meth)acrylic esters and (meth)acrylamides, such as N,N-dialkylaminoalkyl(meth)acrylates or N,N-dialkylaminoalkyl(meth)acrylamides; examples are N,N-dimethylaminoethyl acrylate, N,N-dimethylaminoethyl methacrylate, N,N-diethylaminoethyl acrylate, N,N-diethylaminoethyl methacrylate, N,N-dimethylaminopropyl acrylate, N,N-dimethylaminopropyl methacrylate, N,N-diethylaminopropyl acrylate, N,N-diethylaminopropyl methacrylate, 2-(N,N-dimethylamino)ethylacrylamide, 2-(N,N-dimethylamino)ethylmethacrylamide, 2-(N, N-diethylamino)ethylacrylamide, 2-(N,N-diethylamino)ethylmethacrylamide, 3-(N,N-dimethylamino)propylacrylamide and 3-(N,N-dimethylamino)propylmethacrylamide.

Compounds of the formula VII which are selected by way of example are vinyl acetate, vinyl propionate, vinyl butyrate, vinyl 2-ethylhexanoate and vinyl laurate.

Very particularly preferably used monomers (C) are: acrylic acid, methacrylic acid, methyl acrylate, methyl methacrylate, acrylamide, vinyl n-butyl ether, vinyl isobutyl ether, N-vinylformamide, N-vinylpyrrolidone, 1-vinylimidazole and 4-vinylpyridine.

In an embodiment of the present invention, the molar ratio (A): (B) is from 1:0.1 to 10, preferably from 1:0.2 to 5, particularly preferably from 1:0.3 to 3.

In an embodiment of the present invention, the molar ratio (A) to (C) is from 1:0 to 1:10, preferably from 10:1 to 1:5, particularly preferably from 5:1 to 1:3.

In an embodiment of the present invention, the molar ratio (A) to [(B)+(C)] is from 2:1 to 1:20, preferably from 1:1 to 1:10, particularly preferably from 1:1 to 1:6.

The preparation of the polymers used in the novel process can be carried out by methods known per se. Thus, it is possible to copolymerize the monomers (A), (B) and, if required, (C) with one another by solution polymerization, precipitation polymerization or in the absence of a solvent by mass polymerization and to react the product with (D). (A), (B) and, if required, (C) may copolymerize in the form of random copolymers, as alternating copolymers or as block copolymers.

Pressure and temperature conditions for a copolymerization of (A), (B) and, if required, (C) are generally not critical. The temperature is, for example, from 40 to 200° C., preferably from 60 to 150° C., and the pressure is, for example, from 1 to 10, preferably from 1 to 3, bar.

Suitable solvents are those which are inert toward anhydrides of dicarboxylic acids of 4 to 8 carbon atoms, in particular acetone, tetrahydrofuran or 1,4-dioxane. Suitable precipitating agents are aromatic and aliphatic hydrocarbons, for example toluene, ortho-xylene, meta-xylene, para-xylene, ethylbenzene and mixtures of one or more of the abovementioned aromatic hydrocarbons, n-hexane, petroleum ether and isododecane. Mixtures of aromatic and aliphatic hydrocarbons are also suitable.

It is possible to use regulators, for example mercaptoethanol or n-dodecyl mercaptan. Suitable amounts are, for example, from 0.1 to 6% by weight, based on the mass of all monomers.

The copolymerization is advantageously initiated by initiators, for example peroxides or hydroperoxides. Examples of peroxides and hydroperoxides are di-tert-butyl peroxide, tert-butyl peroctanoate, tert-butyl perpivalate, tert-butyl per-2-ethylhexanoate, tert-butyl permaleate, tert-butyl perisobutyrate, benzoyl peroxide, diacetyl peroxide, succinyl peroxide, p-chlorobenzoyl peroxide and dicyclohexyl peroxodicarbonate. The use of redox initiators is also suitable, and also azo compounds, such as 2,2′-azobisisobutyronitrile, 2,2′-azobis(2-methylpropionamidine)dihydrochloride and 2,2′-azobis(4-methoxy-2,4-dimethylvaleronitrile). In general, these initiators are used in amounts of from 0.1 to 20, preferably from 0.2 to 15,% by weight, calculated relative to the mass of all monomers.

By means of the copolymerization described above, copolymers are obtained. The resulting copolymers can be subjected to a purification by conventional methods, for example reprecipitation or extractive removal of unconverted monomers. If a solvent or precipitating agent was used, it is possible to remove this after the end of the copolymerization, for example by distillation.

In an embodiment of the present invention, the resulting copolymers are not subjected to additional purification and are reacted immediately with (D).

In a further embodiment of the present invention, the copolymerization is carried out in the presence of the total amount or proportion of the compound (D) to be used. In this embodiment it is possible partly or completely to dispense with the use of solvents or precipitating agents. The removal of any solvents or precipitating agents used is therefore simpler or is completely superfluous.

The reaction of the copolymers described above with (D) is effected, for example, at from 90 to 150° C.

The reaction of the copolymers described above with (D) is effected, for example, at from 1 to 10, preferably from 1 to 3, bar. The amount of (D) is calculated so that complete conversion of (D) is assumed and from 5 to 80, preferably from 10 to 67, particularly preferably from 20 to 50, mol %, based on all carboxyl groups of the copolymer, of (D) are used.

The duration of the reaction of the copolymers described above with (D) is in general from 0.1 to 8, preferably from 1 to 5, hours.

The reaction of the copolymers described above with (D) can be carried out in the presence or absence of catalysts, in particular acidic catalysts, e.g. sulfuric acid, methanesulfonic acid, p-toluenesulfonic acid, n-dodecylbenzenesulfonic acid, hydrochloric acid or acidic ion exchangers.

In a further variant of the process described, the reaction of the copolymers descried above with (D) is carried out in the presence of an entraining agent which forms an azeotrope with any water formed in the reaction.

In general, under the conditions of the steps described above, Ia or Ib reacts completely or in a certain percentage with the carboxyl groups of the anhydrides (A) and, if required, the carboxyl groups from (C). In general, less than 40 mol % remain behind as unconverted Ia or Ib.

It is possible, by methods known per se, for example extraction, to separate unconverted Ia or Ib from the polymers used in the novel process.

In an embodiment, the further step of separating unreacted Ia or Ib from the polymers used in the novel process can be dispensed with. In this embodiment, the polymers described above are used together with a certain percentage of unreacted Ia or Ib for the production of leather.

In a further embodiment, the polymers are reacted with water or with aqueous alkaline solution, and partially or completely hydrolyzed polymers are obtained, which are also referred to below as hydrolyzed polymers.

The hydrolysis is carried out according to the invention in such a way that the novel polymers are reacted with water or aqueous alkaline solution, for example of alkali metal hydroxides, such as sodium hydroxide or potassium hydroxide, or of ammonia, primary, secondary or tertiary alkylamines or alkanolamines. Sodium hydroxide solution and potassium hydroxide solution are particularly suitable. For example, from about 20 to 50% by weight, based on copolymer, of water or aqueous alkaline solution are used.

The temperature during the hydrolysis is in general not critical. In general, from 20 to 100° C., preferably up to 90° C., is suitable. Usually, the hydrolysis is complete after from 10 minutes to 4 hours.

Hydrolyzed polymers in which the anhydride groups not converted in the reaction with (D) are completely or partially hydrolyzed and the carboxyl groups are present in the free form or in the form of their alkali metal salts or ammonium salts are obtained.

The polydispersity of the hydrolyzed polymers described above is in general from 2 to 10, preferably up to 7.

The K values of the hydrolyzed polymers described above are from 6 to 100, preferably from 10 to 60 (measured according to H. Fikentscher at 25° C. in water and at a polymer concentration of 1% by weight).

The polymers or hydrolyzed polymers described above can be used, according to the invention, in the pretanning or tanning. The polymers or hydrolyzed polymers described above can be used, according to the invention, in the retanning.

The novel process for the production of leather can be carried out as a process for pretanning or tanning, also referred to below as novel tanning process. The novel tanning process starts from hides of animals, for example cattle, pigs, goats or deer, which have been pretreated by conventional methods, i.e. pelts. It is not important for the novel tanning process whether the animals were killed, for example by slaughtering, or died of natural causes. The conventional methods for the pretreatment include, for example, liming, deliming, bating and pickling and mechanical operations, for example fleshing of the hides.

The novel tanning process is carried out in general in such a way that one or more novel tanning agents are added in one portion or in a plurality of portions immediately before or during the tanning step. The novel tanning process is preferably carried out at a pH of from 2.5 to 4, it frequently being observed that the pH increases by about 0.3 to three units while the novel tanning process is being carried out. The pH can also be increased by about 0.3 to three units by adding basifying agents.

The novel tanning process is carried out in general at from 10 to 45° C., preferably from 20 to 30° C. A duration of from 10 minutes to 12 hours, preferably from one to three hours, has proven useful. The novel tanning process can be carried out in any desired vessels customary in the tannery, for example by drumming in barrels or in rotating drums.

In a variant of the novel tanning process, the polymers or hydrolyzed polymers described above are used together with one or more conventional tanning agents, for example with chrome tanning agents, mineral tanning agents, syntans, polymer tanning agents or vegetable tanning agents, as described, for example, in Ullmann's Encyclopedia of Industrial Chemistry, Volume A15, pages 259 to 282 and in particular page 268 et seq., 5th edition (1990), Verlag Chemie Weinheim. The weight ratio of polymers or hydrolyzed polymer described above to conventional tanning agent or the sum of the conventional tanning agents is expediently from 0.01:1 to 100:1. In an advantageous variant of the novel process, only a few ppm of the conventional tanning agents are added to the polymers or hydrolyzed polymers described above. However, it is particularly advantageous completely to dispense with the admixing of conventional tanning agents.

In a variant of the novel tanning process, polymers or hydrolyzed polymers described above are added in one portion or in a plurality of portions before or during the pretanning, and in a particular variant as early as during pickling.

The novel process for the production of leather can also be carried out as a process for retanning leather using the polymers or hydrolyzed polymers described above, also referred to below as novel retanning process. The novel retanning process starts from semifinished products tanned conventionally, i.e. for example with chrome tanning agents, mineral tanning agents, polymer tanning agents, aldehydes, syntans or resin tanning agents, or semifinished products produced according to the invention as described above. For carrying out the novel retanning process, the polymers or hydrolyzed polymers described above are allowed to act on semifinished products.

The novel retanning process can be carried out under otherwise conventional conditions. Expediently, one or more, i.e. from 2 to 6, action steps are chosen, and washing with water can be effected between the action steps. The temperature during the individual action step is in each case from 5 to 60° C., preferably from 20 to 45° C. Expediently, further compositions conventionally used during the retanning are, for example fatliquor, polymer tanning agents, and acrylate- and/or methacrylate-based fatliquoring agents, retanning agents based on resin and vegetable tanning agents, fillers, leather dyes or emulsifiers.

A further aspect of the present invention relates to aqueous dispersions and solutions comprising the hydrolyzed polymers described above. In the context of the present invention, dispersions are to be understood as meaning, for example, emulsions or suspensions of the polymers described above. The novel aqueous dispersions and the novel aqueous solutions usually comprise from 20 to 50% by weight of the novel polymers. Their pH is usually from 2 to 10, preferably from 2 to 7.

Where unreacted Ia or Ib has not been separated off after the preparation of the polymers described above, the novel dispersions comprise unreacted Ia or Ib.

A further aspect of the present invention relates to leather produced by the novel tanning process or the novel retanning process or by a combination of the novel tanning process and novel retanning process. The novel leathers have a generally advantageous quality, for example they feel particularly soft. The novel leathers comprise the polymers described above or the hydrolyzed polymers described above distributed particularly uniformly over the cross section.

A further aspect of the present invention relates to the use of the novel leathers for the production of articles of clothing, pieces of furniture or automotive parts. In the context of the present invention, articles of clothing are, for example, jackets, pants, shoes, belts or suspenders. Pieces of furniture in association with the present invention are all those pieces of furniture which comprise leather components. Examples are seating furniture, such as arm chairs, chairs and sofas. Examples of automotive parts are automobile seats.

A further aspect of the present invention relates to articles of clothing comprising the novel leathers or produced from novel leathers. A further aspect of the present invention relates to furniture comprising the novel leathers or produced from novel leather. A further aspect of the present invention relates to automotive parts comprising the novel leathers or produced from novel leathers.

The invention is illustrated by working examples.

1. Synthesis Method for the Polymerization

1.1 Synthesis Method for the Polymerization with Polymer P1 as an Example

108 g (1.10 mol) of maleic anhydride were dissolved in 550 g (1.10 mol) of D1 methylpolyethylene glycol having an average molecular weight M_{w} of 500 g/mol and heated to 90° C. in a nitrogen atmosphere while stirring. At this temperature, 6 g of tert-butyl peroctanoate and a solution of 12 g (0.14 mol) of methacrylic acid in 100 g (0.96 mol) of styrene were slowly added dropwise in the course of two hours. The reaction mixture obtained was then stirred for 4 hours at 150° C., a brown oil being formed. It was cooled to 50° C. The oil was taken up in 500 ml of water and the solution was brought to pH 6-7 with 25% by weight of sodium hydroxide solution.

A 41% by weight low-viscosity polymer solution having a K value of 36 (1% in H₂O) was obtained.

1.2 to 1.9 Polymers P2 to P9

Process 1.1 was employed, but the starting materials were selected as shown in table 1.

TABLE 1

| | (A): Maleic anhydride | (B): Styrene | (C) | (D) | K value (1% by |
|---|---|---|---|---|---|
| Polymer | [g (mol)] | [g (mol)] | [g (mol)] | [g (mol)] | weight in H₂O) |
| P2 | 108 (1.10) | 102 g (1.00) | n-Butyl vinyl | D1 | 13 |
| | | | ether | 550 (1.10) | |
| | | | 11 (0.11) | | |
| P3 | 108 (1.10) | 102 (1.00 mol) | C1 | D1 | 20 |
| | | | 50 (0.12) | 550 (1.10) | |
| P4 | 108 (1.10) | 86 (0.84 mol) | Methyl | D1 | 25 |
| | | | methacrylate | 550 (1.10 mol) | |
| | | | 28 (0.28 mol) | | |
| P5 | 108 (1.10) | 102 (1.00) | N-Vinyl- | D1 | 43 |
| | | | pyrrolidone | 550 (1.10 mol) | |
| | | | 12 (0.11) | | |
| P6 | 108 (1.10) | 92 (0.90) | Acrylic acid | D3 | 48 |
| | | | 16 (0.22) | 560 (1.10) | |
| P7 | 108 (1.10) | 115 (1.12) | Acrylic acid | D1 | 51 |
| | | | 79 (1.10) | 550 (1.10 mol) | |
| P8 | 108 (1.10) | 229 (2.20) | Acrylic acid | D2 | 43 |
| | | | 159 (2.20) | 1100 (1.10) | |
| P9 | 108 (1.10) | 114 (1.10) | — | D1 | 33 |
| | | | | 550 (1.10) | |

D1: Methylpolyethylene glycol having a molar mass M_{w} of about 500 g/mol
D2: Methylpolyethylene glycol having a molar mass M_{w} of about 1 000 g/mol
D3: C₁₅H₃₁—O—(CH₂—CH₂—O)₇—H
C1: CH₂═CH—CH₂—O(CH₂—CH₂—O)₁₀—H

1.10 Preparation of the Polymers P10 to P14

1.10.1 Preparation of the Intermediate VP10 for Polymers P10 to P12

194 g (2.11 mol) of maleic anhydride were dissolved together with 20 g of C2, polyethyl vinyl ether having a K value of 50, measured in cyclohexanone (1% by weight at 25° C. according to H. Fikentscher) in 900 g of ortho-xylene and heated to 140° C. in a nitrogen atmosphere while stirring. At 140° C., a mixture consisting of 220 g (2.16 mol) of styrene and 158 g (2.20 mol) of acrylic acid, and a solution of 4 g of di-tert-butyl peroxide in 36 g of ortho-xylene, were added simultaneously in the course of four hours. Thereafter, stirring was continued for a further hour at 140° C., cooling to 50° C. was effected and the solvent was distilled off under reduced pressure.

The K value of the intermediate VP10 present in the form of a white powder was 15.9 (1% by weight in cyclohexanone at 25° C.).

1.10.2 Preparation of the Intermediate VP13 for Polymers P13 and P14

228 g (2.32 mol) of maleic anhydride were dissolved together with 20 g of C2 in 1 100 g of ortho-xylene and heated to 140° C. in a nitrogen atmosphere while stirring. At 140° C., a mixture consisting of 230 g (2.25 mol) of styrene and 1 300 g (18.06 mol) of acrylic acid, and a solution of 12 g of di-tert-butyl peroxide in 140 g of ortho-xylene, were added simultaneously in the course of four hours. Thereafter, stirring was effected for one hour at 140° C., cooling to 50° C. was effected and the solvent was distilled off under reduced pressure. The K value of the VP12 present in the form of a white powder was 24.2 (1% by weight of cyclohexanone at 25° C.).

1.10.3 Reaction of the Intermediates VP 10 and VP 13

The preparation of the polymers P10 to 14 from the intermediate VP 10 or VP 13 and the alkylpolyalkylene glycols stated in table 2 was carried out by heating a mixture of two components under nitrogen. The reaction was carried out in the course of 4 hours at 170° C. After cooling to 50° C., the oil was dispersed with 50 g of water and 10 g of aqueous 25% by weight sodium hydroxide solution. The molar ratio NaOH/(sum of maleic anhydride and acrylic acid) was 0.6/1.0, so that from 30 to 40% by weight dispersions having a pH of from 6 to 7 resulted.

TABLE 2

| | | D [mol per mol | K value |
|---|---|---|---|
| Polymer | Intermediate | of maleic anhydride] | (1% by weight in H₂O) |
| P10 | VP10 | D5 | 32 |
| | | 0.75 | |
| P11 | VP10 | D6 | 35 |
| | | 0.75 | |
| P12 | VP10 | D3 | 29 |
| | | 1.0 | |
| P13 | VP13 | D2 | 43 |
| | | 1.0 | |
| P14 | VP13 | D6 | 36 |
| | | 1.0 | |

D5: n-Butylpolyalkylene glycol (ethylene glycol/propylene glycol copolymer, molar fraction of ethylene glycol units:propylene glycol units 50:50) having an M_{w} of about 1 000 g/mol
D6: C₁₅H₃₁—O—(CH₂—CH(CH₃)—O)₃(CH₂—CH₂—O)₁₂—H

2. Production of Upper Leather and Testing of Performance Characteristics

All data in % by weight are based on the shaved weight, unless stated otherwise.

2.1 Production of Upper Leather Using Polymer P1

Zebu wet blue leather, commercially available from Packer, USA, was shaved to a thickness of 1.8-2.0 mm and cut into strips of 600 g each. Thereafter, 2% by weight of sodium formate, 0.4% by weight of NaHCO₃ and 1% by weight of Tamol®NA, commercially available from BASF Aktiengesellschaft, were added to the strips in a barrel at intervals of 10 minutes, the liquor length being 200% by weight. After 90 minutes, the liquor was discharged. The strips were then distributed over separate drumming barrels.

1% by weight of the dye Luganil® brown, commercially available from BASF Aktiengesellschaft, were metered at 25-35° C., together with 100% by weight of water, and drumming was effected for 10 minutes in the barrel.

Thereafter, 4% by weight of polymer P1 were metered, followed by 4% by weight of sulfone tanning agent Basyntan® DLX, commercially available from BASF Aktiengesellschaft, and 2% by weight of resin tanning agent Relugan® DLF, commercially available from BASF Aktiengesellschaft. The leathers were then drummed in the barrel for 45 minutes at 15 revolutions per minute. Thereafter, 3% by weight of vegetable tanning agent Mimosa®, commercially available from BASF Aktiengesellschaft, were added and drumming was effected for a further 30 minutes. Thereafter, a further 2% by weight of Luganil® brown were added and drumming was effected for a further 30 minutes.

A pH of 3.6-3.8 was then established with formic acid. After 20 minutes, the liquor was evaluated with regard to the exhaustion and was discharged, and the leather was, washed was 200% by weight of water. Finally, a 5% by weight of Lipodermlicker® CMG and 2% by weight of Lipodermlicker® PN in 100% of water were metered at 50° C. and drumming was continued at this temperature. After a drumming time of 45 minutes, acidification was effected with 1% by weight of formic acid.

The leather thus obtained was washed with water, dried and staked and evaluated according to the test criteria specified in table 3. The tensile strength was determined according to DIN 53328. The liquor exhaustion was evaluated visually according to the criteria of residual dye (extinction) and turbidity (fatliquoring agent). The evaluation of the further performance characteristics was effected by test subjects according to a rating system from 1 (very good) to 5 (poor).

TABLE 3
Performance characteristics of the novel leathers 2.1
to 2.9 and comparative samples V 2.17 to V 2.19

| | | | | | | Tensile | Dye | Levelness |
|---|---|---|---|---|---|---|---|---|
| | | Liquor | | Grain | | strength | penetration | Color/ |
| No. | Polymer | exhaustion | Body | tightness | Softness | [N] | (section) | Fat-liquoring |
| 2.1 | P1 | 2.5 | 2.5 | 3 | 2.5 | 409 | 3 | 3 |
| 2.2 | P2 | 3 | 2 | 2 | 2 | 423 | 2 | 2 |
| 2.3 | P3 | 2 | 1.5 | 2.5 | 2 | 438 | 1 | 2 |
| 2.4 | P4 | 1.5 | 2 | 2.5 | 2.5 | 440 | 1.5 | 2.5 |
| 2.5 | P5 | 2.5 | 1.5 | 2 | 3 | 445 | 1.5 | 1.5 |
| 2.6 | P6 | 2 | 2.5 | 2 | 2 | 415 | 1 | 1 |
| 2.7 | P7 | 2.5 | 2.5 | 1.5 | 1 | 418 | 2 | 2 |
| 2.9 | P9 | 3 | 2 | 2.5 | 2.5 | 405 | 2.5 | 2.5 |
| V 2.17 | V17 | 4 | 3 | 3.5 | 3 | 428 | 4 | 3 |
| V 2.18 | V18 | 3 | 3 | 3 | 2.5 | 410 | 3 | 3.5 |
| V 2.19 | V19 | 3.5 | 4 | 4 | 2 | 400 | 3.5 | 3 |

The following polymers were used for the comparative experiments.

Polymer V17: Polyacrylic acid having a K value of 60, determined according to Fikentscher, partially neutralized with NaOH to a pH of 5.

Polymer V18: Polymer from EP-B 0 628 085, example 18

Polymer V19: Polymer from EP-B 0 628 085, example 20.

3. Production of Upholstery Leather

General Method

A Southern German cattle pelt was converted into a corresponding wet white semifinished product using 2.5% by weight of glutaraldehyde and 3% by weight of the sulfone tanning agent Basyntan®, commercially available from BASF Aktiengesellschaft, based in each case on the pelt weight. After the pretanning, the pH was 3.9. The pretanned pelt was sammed, shaved to a thickness of 1.2 mm and cut into strips of 400 g each.

Below, all data in % by weight are based on the shaved weight, unless stated otherwise.

In a barrel, strips were treated with 100% by weight of water, 6% by weight of the sulfone tanning agent Basyntan® DLX-N, 5% by weight of the vegetable tanning agent Tara®, 3% by weight of the resin tanning agent Relugan® S and 1.5% by weight of the dye Luganil brown NGB®, in each case commercially available from BASF Aktiengesellschaft, over a period of 60 minutes at 25-30° C. at 10 revolutions per minute. Thereafter, a pH of 3.6 was established with formic acid and, after a further 20 minutes, the liquor was discharged and discarded. 100% by weight of water were added and 5% by weight of a polymer dispersion according to table 3 were metered in, followed by 6% by weight of Lipodermlicker CMG®, 1% by weight of Lipamin® OK and 1.5% by weight of Luganil brown NGB®, in each case commercially available from BASF Aktiengesellschaft.

After a drumming time of 60 minutes, acidification was effected with formic acid to a pH of 3.2, and corresponding samples were taken before the liquor was discharged. The leathers were washed twice with 100% of water each time, stored moist overnight, and dried on a toggle frame at 50° C. after drumming. After staking, the leathers were assessed as below.

The leather thus obtained was washed with water, dried and staked and evaluated according to the test criteria specified in table 3. The tensile strength was determined according to DIN 53328. The liquor exhaustion was evaluated visually according to the criteria of residual dye (extinction) and turbidity (fatliquoring agent). The evaluation of the further performance characteristics was carried out by test subjects according to a rating system from 1 (very good) to 5 (poor).

TABLE 4
Performance characteristics of the novel upholstery leathers
3.8 to 3.14 and of the comparative samples V 3.17 to V 3.19

| | | | | | | Tensile | Dye | Levelness |
|---|---|---|---|---|---|---|---|---|
| | | Liquor | | Grain | | strength | penetration | Color/ |
| No. | Polymer | exhaustion | Body | tightness | Softness | [N] | (section) | Fat-liquoring |
| 3.8 | P8 | 3 | 2 | 2 | 2.5 | 238 | 2.5 | 3 |
| 3.9 | P9 | 2.5 | 1.5 | 2.5 | 2 | 245 | 2 | 2 |
| 3.10 | P10 | 1.5 | 2 | 2.5 | 3 | 227 | 2 | 2.5 |
| 3.11 | P11 | 1.5 | 2 | 2 | 2.5 | 246 | 1.5 | 1 |
| 3.12 | P12 | 2 | 1 | 2.5 | 2.5 | 241 | 2 | 1 |
| 3.13 | P13 | 2.5 | 2.5 | 2 | 3 | 230 | 2 | 1.5 |
| 3.14 | P14 | 2 | 2 | 2.5 | 2.5 | 238 | 1.5 | 2 |
| V 3.17 | V17 | 4 | 3 | 3.5 | 3 | 230 | 4 | 3 |
| V 3.18 | V18 | 3 | 3 | 3 | 3.5 | 236 | 3.5 | 3.5 |
| V 3.19 | V19 | 3.5 | 4 | 3 | 2.5 | 240 | 3 | 3 |

The following polymers were used for the comparative experiments.

Polymer V17: Polyacrylic acid having a K value of 60, determined according to Fikentscher, partially neutralized with NaOH to a pH of 5.

Polymer V18: Polymer from EP-B 0 628 085, example 18

Polymer V19: Polymer from EP-B 0 628 085, example 20.

1. A process for the production of leather, wherein pelts, pickled pelts or semifinished products are treated with at least one polymer which is obtainable by copolymerization of at least one ethylenically unsaturated dicarboxylic anhydride (A), derived from at least one dicarboxylic acid of 4 to 8 carbon atoms, at least one vinylaromatic compound (B) and optionally at least one ethylenically unsaturated monomer (C) differing from (A) and having at least one hetero atom, reaction with at least one compound (D) of the formula Ia or Ib 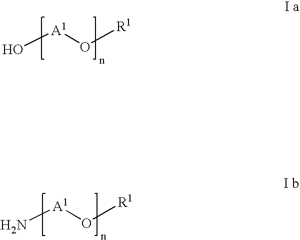
at least 0.55 equivalent, based on (A), of (D) being used,
and optionally hydrolysis with water or aqueous alkaline solution,
in formulae Ia and Ib the variables being defined as follows:
A¹ are identical or different and are C₂-C₆-alkylene
R¹ is linear or branched C₁-C₂₀-alkyl and
n is an integer from 6 to 200.
1.

2. A process as claimed in claim 1, wherein the polymer is treated with water or aqueous alkaline solution before use.

3. The process of claim 1, wherein (B) is styrene.

4. The process of claim 1, wherein the molar ratio of (A) to (C) is from 1:0 to 1:10.

5. The process of claim 1, wherein the molar ratio of (A) to [(B)+(C)] is from 2:1 to 1:20.

6. The process of claim 1, wherein (C) is selected from the group consisting of ethylenically unsaturated C₃-C₈-carboxylic acid derivatives of the formula II 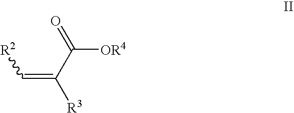
acrylamides of the formula III 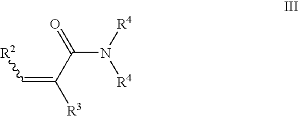
acyclic amides of the formula IVa, cyclic amides of the formula IVb 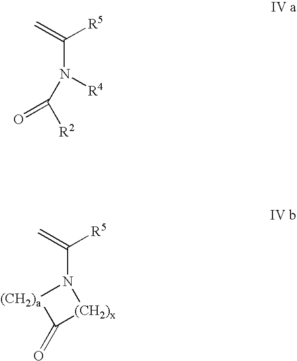
C₁-C₂₀alkyl vinyl ethers, N-vinyl derivatives of nitrogen-containing aromatic compounds, α,β-unsaturated nitriles, alkoxylated unsaturated ethers of the formula V 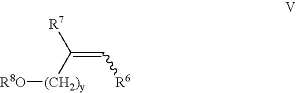
esters of the formula VI, amides of the formula VI 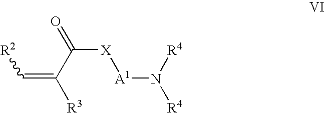
and unsaturated esters of the formula VII 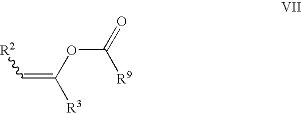
in the formulae the variables being defined as follows:
R² and R³ are identical or different and are selected from hydrogen and straight-chain and branched C₁-C₁₀-alkyl,
R⁴ are identical or different and are selected from hydrogen and branched and straight-chain C₁-C₂₂-alkyl,
R⁵ is hydrogen or methyl,
x is an integer from 2 to 6,
y is an integer selected from 0 and 1,
a is an integer from 0 to 6,
R⁶ and R⁷ are identical or different and are selected from hydrogen and straight-chain and branched C₁-C₁₀-alkyl,
X is oxygen or N—R⁴
R⁸ is [A¹-O]ₙ—R⁴,
R⁹ are identical or different and are selected from hydrogen and straight-chain and branched C₁-C₁₀-alkyl
and the remaining variables are as defined above.

7. The process of claim 1, wherein the hydrolysis is carried out at from 15 to 100° C.

8. The process of claim 1, wherein the polymers are metered as an aqueous dispersion or solution.

9. A leather produced by a process of claim 1.

10. The use of a leather as claimed in claim 9 for the production of articles of clothing or furniture or automotive parts.

11. An article of clothing, produced from or comprising leather as claimed in claim 9.

12. A piece of furniture produced from or comprising leather as claimed in claim 9.

13. An automotive part produced from or comprising leather as claimed in claim 9.
